(19) United States
(12) Patent Application Publication
(10) Pub. No.: US 2009/0064987 A1
(43) Pub. Date: Mar. 12, 2009

(54) GRATE APPARATUS AND METHOD

(76) Inventor: Paul Bryan Cadima, Prospect, KY (US)

Correspondence Address: General Electric Company;GE Global Patent Operation, PO Box 861, 2 Corporate Drive, Suite 648, Shelton, CT, 06484, US

(21) Appl. No.: 11/852,578

(22) Filed: Sep. 10, 2007

(51) Int. Cl. F24C 15/10; B05D 5/00

(52) U.S. Cl. 126/215; 427/224

(57) ABSTRACT

A grate apparatus configured to support a cooking utensil over a flame of a heat source on a cooktop stove. The grate apparatus includes an outer portion with a support surface configured to support the cooking utensil. The support surface includes a first coating. A plurality of protrusions is configured to support the cooking utensil. A portion of the plurality of protrusions is configured to be disposed closer to the flame of the heat source than is an entirety of the support surface. The plurality of protrusions includes a second coating different than the first coating.

### BACKGROUND OF THE INVENTION

The described technology relates to a grate apparatus, such as for a cooktop stove, and a corresponding method.

It is known to use a grate on a cooktop, such that a cooking utensil is spaced apart from a heat source used to heat the cooking utensil. The heat source produces a flame by combustion of natural gas or propane.

It is also known to form the grate from cast iron, and to coat the grate with porcelain enamel. The coated grate is easier to clean and has a more attractive appearance as compared to an uncoated grate. However, the porcelain enamel coating is susceptible to discoloration and staining, especially when subjected to high temperatures from the heat source. Thus, the aesthetic quality of the porcelain enamel coated grate is negated.

Therefore, it may be desirable to coat the grate with a material that is more resistant to discoloration and staining as compared to, and that has better stain release properties than, porcelain enamel. Particles of foodstuffs exposed to high temperatures do not adhere to such a coating as they do to the porcelain enamel coating. However, application of such a coating is generally much more expensive than application of the porcelain enamel coating. For these reasons, it would be advantageous to provide a cost-effective grate that resists discoloration and staining and that has good stain release properties.

### SUMMARY OF THE INVENTION

As described herein, embodiments of the invention overcome one or more of the above or other disadvantages known in the art.

The present invention provides a grate apparatus configured to support a cooking utensil over a flame of a heat source on a cooktop stove. The grate apparatus includes an outer portion with a support surface configured to support the cooking utensil. The support surface includes a first coating. A plurality of protrusions is configured to support the cooking utensil. A portion of the plurality of protrusions is configured to be disposed closer to the flame of the heat source than is an entirety of the support surface. The plurality of protrusions includes a second coating that is different than the first coating. A non-limiting example of the first coating is porcelain enamel. It is to be understood, however, that a different first coating can be used.

The present invention further provides a grate apparatus configured to support a cooking utensil over a flame of a heat source on a cooktop stove. The grate apparatus includes means for supporting an outer portion of the cooking utensil. The means for supporting the outer portion includes a first coating. A portion of means for supporting an inner portion of the cooking utensil is configured to be disposed closer to the flame of the heat source than is an entirety of the means for supporting the outer portion. The means for supporting the inner portion includes a second coating different than the first coating.

The present invention still further provides a method of fabricating a grate apparatus configured to support a cooking utensil over a flame of a heat source on a cooktop stove. A first support surface of the grate, which is configured to support the cooking utensil, is coated with a first coating. A second support surface of the grate, which is configured to support the cooking utensil, is coated with a second coating that is different than the first coating. A portion of the second support surface is configured to be disposed closer to the flame than an entirety of the first support surface.

### BRIEF DESCRIPTION OF THE DRAWINGS

The following figures illustrate examples of embodiments of the invention. The figures are described in detail below.

FIG. 1 is a top isometric view of embodiments of a grate apparatus.

FIG. 2 is a top isometric view of another embodiment of the grate apparatus.

### DETAILED DESCRIPTION OF EMBODIMENTS OF THE INVENTION

Embodiments of the invention are described below, with reference to the figures. Throughout the figures, like reference numbers indicate the same or similar components.

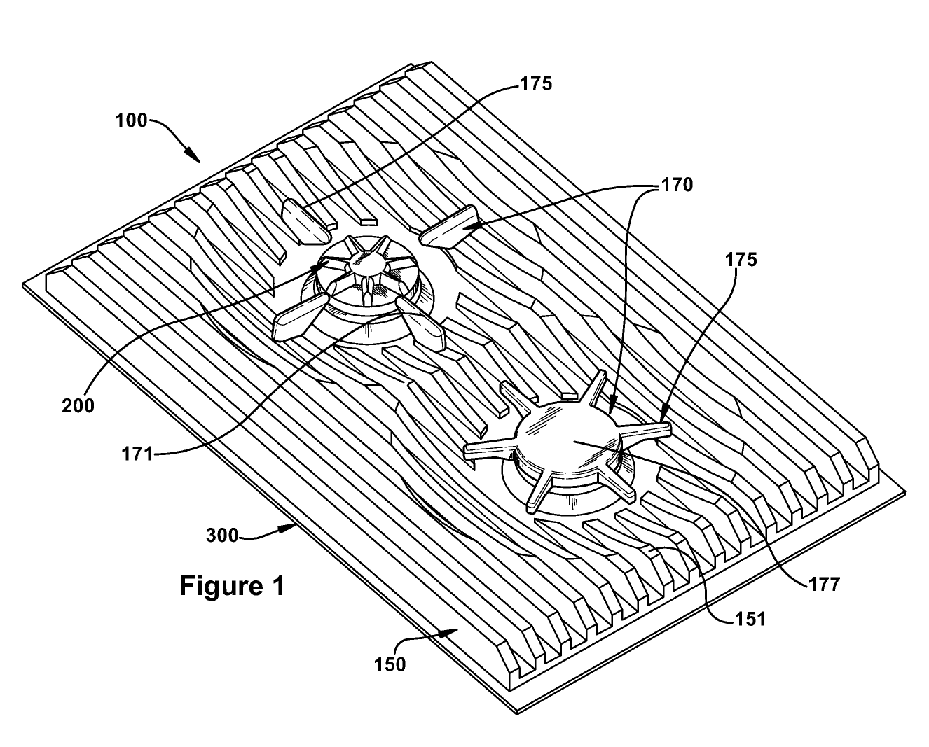

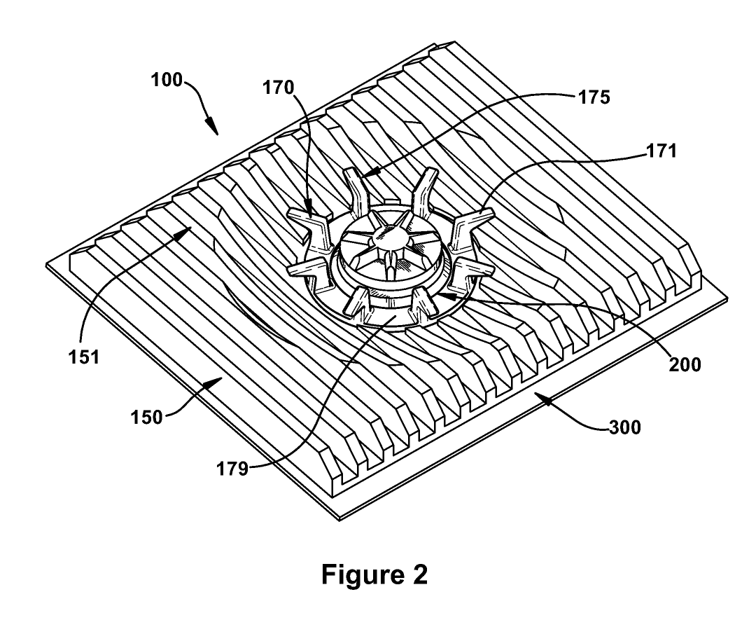

FIGS. 1 and 2 are top isometric views of embodiments of a grate apparatus. The grate apparatus 100 is configured to support a cooking utensil (e.g., a pot, pan, skillet or the like) over a flame of a heat source 200 on a cooktop stove 300. In embodiments of the invention, the heat source 200 can, but need not, produce the flame by combustion of natural gas or propane. The cooktop stove 300 can, but need not, be a cooktop separate from a range, or a cooktop in a free-standing, slide-in or drop-in range.

As shown in the figures, the grate apparatus 100 includes a grate outer portion 150 (referred to as an outer portion 150) and a grate inner portion 170 (referred to as an inner portion 170). At least a portion of the inner portion 170 is configured to be disposed closer to the flame of the heat source 200 than is an entirety of the outer portion 150. Restated, a closest part of the inner portion 170 is closer to the flame than a closest part of the outer portion 150.

The outer portion 150 includes an outer portion support surface 151. The outer portion support surface 151 is a surface of the outer portion 150 which is configured to support the cooking utensil and/or to be adjacent to a surface of the inner portion 170 which is configured to support the cooking utensil (e.g., the outer portion support surface 151 can be a top surface of the outer portion 150). It is to be understood that depending on a size of the cooking utensil supported on the grate apparatus 100, the outer portion support surface 151 may or may not actually support the cooking utensil. For example, the inner portion 170 can support an entirety of the cooking utensil (e.g., a bottom surface of the cooking utensil) when the cooking utensil is relatively small.

The outer portion support surface 151 is coated with a first coating. In embodiments of the invention, the first coating is a coating that includes porcelain enamel, such as a known porcelain enamel coating that is commonly used on a grate. It is to be understood, however, that the first coating is not limited to porcelain enamel, or to a known or commonly used porcelain enamel coating for a grate.

The inner portion 170 includes an inner portion support surface 171. The inner portion support surface 171 is a surface of the inner portion 170 which is configured to support the cooking utensil (e.g., a top surface of the inner portion 170). The inner portion support surface 171 is coated with a second coating. In embodiments of the invention, the second coating is a material resistant to discoloration and staining and that has good stain release properties. For example, the second coating can include a material that is impervious to damage by acids, alkalis, food soils, solvents and the like. It is to be understood, however, that the second coating is not limited to any specific coating, but can be any coating that has one or more of resistant to discoloration, resistance to staining, good stain release properties and/or good cleanability, and/or that has better resistant to discoloration, better resistance to staining, better release properties and/or better cleanability than the first coating.

In the embodiments shown in the figures, the inner portion 170 includes a plurality of protrusions 175. The protrusions 175 provide the inner portion support surface 171 that is configured to support the cooking utensil. It is to be understood, however, that the inner portion 170 is not required to include the protrusions 175. For example, the inner portion 170 can include alternate structures that provide the inner portion support surface 171. For example, the inner portion 170 can include structures that intersect with one another, extend parallel to one another, and/or extend parallel to and perpendicular with one another, such that these structures provide the inner portion support surface 171 that is configured to support the cooking utensil.

In an embodiment shown in FIG. 1, the protrusions 175 are separate from and not directly connected to one another. The protrusions 175 can be connected to and irremovable from the outer portion 150. Alternatively, the protrusions 175 can be removably connected to the outer portion 150.

In another embodiment shown in FIG. 1, the protrusions 175 are connected to one another. Specifically, a base portion 177 of the inner portion 170 connects the protrusions 175. A top surface of the base portion 177 is disposed in a same plane as top surfaces of the protrusions 175, such that the protrusions 175 and the base portion 177 provide the inner portion support surface 171 that is configured to support the cooking utensil. Alternatively, embossed or raised portions on a top surface of the base portion 177 are disposed in the same plane as the top surfaces of the protrusions 175, such that the protrusions 175 and the embossed portions provide the inner portion support surface 171

In contrast, in an embodiment shown in FIG. 2, the protrusions 175 are connected to one another through an alternate base portion 179. The alternate base portion 179 is disposed in a first plane at a base of, and surrounding, the heat source 200. Surfaces of the protrusions 175 which are configured to support the cooking utensil (i.e., the inner portion support surface 171) are disposed in a second plane that is offset from the first plane.

It is to be understood that aspects of the components of the grate apparatus 100 are not limited to the specific examples shown in the drawings. For example, the profile of the outer portion 150 is not limited to the illustrated shape, and components of the inner portion 170 (including the shape, arrangement and/or number of protrusions 175) are not limited to those illustrated.

In accordance with the above description, the grate apparatus 100 can be fabricated from a method that includes coating a first support surface of a grate, which is configured to support a cooking utensil, with a first coating. The method can further include coating a second support surface of the grate, which is configured to support the cooking utensil, with a second coating, where a portion of the second support surface is configured to be disposed closer to a flame than an entirety of the first support surface. The second support surface can include a plurality of protrusions configured to support the cooking utensil, the plurality of protrusions separate from or connected to one another, connected to the first support surface, or connected to the base portion, as discussed above.

This written description uses examples to disclose embodiments of the invention, including the best mode, and also to enable a person of ordinary skill in the art to make and use embodiments of the invention. It is understood that the patentable scope of embodiments of the invention is defined by the claims, and can include additional components occurring to those skilled in the art. Such other arrangements are understood to be within the scope of the claims.

1. A grate apparatus configured to support a cooking utensil over a flame of a heat source on a cooktop stove, the grate apparatus comprising:
an outer portion comprising a support surface configured to support the cooking utensil, the support surface comprising a first coating; and
a plurality of protrusions configured to support the cooking utensil, a portion of the plurality of protrusions configured to be disposed closer to the flame of the heat source than is an entirety of the support surface, the plurality of protrusions comprising a second coating different than the first coating.

2. The grate apparatus according to claim 1, wherein the first coating comprises porcelain enamel.

3. The grate apparatus according to claim 1, wherein the protrusions are separate from the outer portion.

4. The grate apparatus according to claim 3, wherein the protrusions are connected to one another.

5. The grate apparatus according to claim 4, wherein the protrusions are connected to a base portion.

6. The grate apparatus according to claim 5, wherein the base portion is disposed in a same plane as surfaces of the protrusions which are configured to support the cooking utensil.

7. The grate apparatus according to claim 5, wherein the base portion is disposed in a first plane, and surfaces of the protrusions which are configured to support the cooking utensil are disposed in a second plane, the first plane offset from the second plane.

8. The grate apparatus according to claim 1, wherein the protrusions are connected to the outer portion.

9. The grate apparatus according to claim 1, wherein the first coating comprises porcelain enamel and the second coating comprises a material having at least one of better resistant to discoloration and better resistance to staining than the first coating.

10. A grate apparatus configured to support a cooking utensil over a flame of a heat source on a cooktop stove, the grate apparatus comprising:
means for supporting an outer portion of the cooking utensil, the means for supporting the outer portion comprising a first coating; and
means for supporting an inner portion of the cooking utensil, a portion of the means for supporting the inner portion configured to be disposed closer to the flame of the heat source than is an entirety of the means for supporting the outer portion, the means for supporting the inner portion comprising a second coating different than the first coating.

11. The grate apparatus according to claim 10, wherein the first coating comprises porcelain enamel.

12. The grate apparatus according to claim 10, wherein the means for supporting the inner portion comprises protrusions that are separate from the means for supporting the outer portion.

13. The grate apparatus according to claim 12, wherein the protrusions are connected to one another.

14. The grate apparatus according to claim 13, wherein the protrusions are connected to a base portion that is separate from the means for supporting the outer portion.

15. The grate apparatus according to claim 10, wherein the means for supporting the inner portion comprises protrusions that are connected to the means for supporting the outer portion.

16. A method of fabricating a grate apparatus configured to support a cooking utensil over a flame of a heat source on a cooktop stove, the method comprising:
coating a first support surface of the grate, which is configured to support the cooking utensil, with a first coating; and
coating a second support surface of the grate, which is configured to support the cooking utensil, with a second coating different than the first coating, a portion of the second support surface configured to be disposed closer to the flame than an entirety of the first support surface.

17. The method of claim 16, wherein the second support surface comprises a plurality of protrusions configured to support the cooking utensil.

18. The method of claim 17, wherein the protrusions are separate from one another.

19. The method of claim 17, wherein the protrusions are connected to one another.

20. The method of claim 17, wherein the protrusions are connected to the first support surface.
